(19) United States
(12) Patent Application Publication
(10) Pub. No.: US 2008/0027572 A1
(43) Pub. Date: Jan. 31, 2008

(54) Automobile Radio Having a Removable MPeg Player

(75) Inventor: Oliver Romoser, Bietigheim-Bissingen (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 11/578,684

(22) PCT Filed: Apr. 11, 2005
(86) PCT No.: PCT/EP05/51589

§ 371 Date: Jul. 30, 2007

(30) Foreign Application Priority Data
Apr. 15, 2004 (DE) 10 2004 018 202.7

(51) Int. Cl. G06F 17/00

(52) U.S. Cl. 700/94

(57) ABSTRACT

An automobile radio having a removable MPeg player, especially an MP3 player, the automobile radio having a base part that includes at least one radio part, the MPeg player being developed as an insertion module and forming a unit with the base part in the inserted state, the MPeg player has operating elements and a display field, the MPeg player is developed as a portable unit, the base part as well as the MPeg player have corresponding electrical contacts which produce a transmission connection in the inserted state, the base part has a freely accessible front face, is designed to permit simple, comfortable handling, and offer a cost-effective design approach as well. This is achieved in that the operating elements and the display field of the MPeg player are situated on the front face, in the inserted state, so that they are able to be operated.

### BACKGROUND INFORMATION

An automobile radio having a removable MPeg player is described in German Patent No. DE-U-299 06 953. The automobile radio is furnished with a push-in compartment at a base part, and on the front face, with an operating part and a display part that are able to be folded down or swiveled. The MPeg player is able to be pushed into the push-in compartment. To do this, the front face of the automobile radio must first be folded down. For the operation of the MPeg player, the front face necessarily has to be folded up again. In order to be able to utilize the MPeg player as a portable unit, the front face of the automobile radio has to be folded down again before the MPeg player can be removed.

On the front face of the automobile radio that is able to be swiveled, according to German Patent No. DE-U-299 06 953, there is a universal operating and display unit. This controls the MPeg player and is also able to indicate music pieces, if necessary. This operating unit, that is situated on the front face that is able to be swiveled, is required, since the control panel of the MPeg player has to submerge completely into the push-in compartment and the operation of operating elements on the MPeg player is not possible because, on the one hand, the front face of the automobile radio could then not be tilted upwards and, on the other hand, no electrical connection between the MPeg player and the automobile radio exists. Additional control contacts have to be mounted for the control of the MPeg player. In addition, further operating elements for the MPeg player have to be present on the front face.

### SUMMARY OF THE INVENTION

The present invention is based on the object of creating an automobile radio having a removable MPeg player, which permits simple, comfortable handling and, in addition, offers a cost-effective design approach.

Multiple usability is created by this development of the automobile radio. The customer is able to use the MPeg player both as a portable unit, as customary, and in the automobile radio during a trip. In this connection, an easy insertion of the MPeg player is fulfilled. In order to insert the MPeg player in the automobile radio, the customer does not have to swivel or change any parts. Pushing it in from in front, in the direction of the automobile radio or by another mounting motion, for instance, by a lateral pushing motion can be achieved in a comfortable manner.

Besides that, the design approach according to the present invention is also cost-effective. Additional contacts for controlling the MPeg player drop out. The control electronics also become simplified. An operation may be undertaken directly by using the front face control panel of the MPeg player. Basically, commercial MPeg players can be used that have only one earphone connection and one current supply connection. Thus, already present sockets may be used for the transmission connection of analog signals, as well as for the current supply.

Because of the widespread use and acceptance of these portable systems or MPeg players, additional drives, such as CD drives and/or cassette drives having mechanical components are not required. In particular, such an automobile radio, in which only digital memories for reproducing music and for voice rendition are present, are expedient. Such an automobile radio without mechanical components has a very long service life. In addition, installation depth may be considerably reduced.

Taking the MPeg player insert along with one, as is also true for the removal of operating parts, is effective as protection from theft.

In one advantageous specific embodiment of the adapter according to the present invention, it is provided that the MPeg player is furnished with an earphone socket, especially a jack connector socket, and the base part has a fitting plug for transmitting analog audio signals of the MPeg player.

Such contact systems work reliably, even during vibrational motions of a vehicle. Their use is widespread, and they are therefore cost-effective. A present earphone pair is compatible with this, in particular, a stereo connector having three contact zones being used. This socket produces the electrical connection of the MPeg player to the base part. It may also be used at least partially for the mechanical connection to the base part.

In one further advantageous specific embodiment of the adapter according to the present invention, it is provided that the MPeg player is furnished with a current supply socket, especially a jack connector socket, and the base part has a fitting plug for the voltage supply of the MPeg player. This development saves the additional mounting of a voltage supply connector. Battery chargers for such sockets may be bought cost-effectively. Here too, this socket connects the base part with its MPeg player insert, preferably, at least partially also, mechanically.

The base part expediently also includes a charging function for accumulators of the MPeg player. The MPeg player is able to be charged automatically during a trip, which saves having to charge it, for instance, at home. In particular, the loading procedure of the accumulators is implemented via the current supply socket of the MPeg player.

In order for the MPeg player to be able to be comfortably carried by a person, for instance, using a belt clip fastener, and to be easily integrated into an operating zone of the automobile radio, the MPeg player has an elongated construction, having approximately the shape of a right parallelepiped, there being preferably four elongated sides and two relatively shorter sides as end faces. An attractively styled and ergonomic design is achieved by rounding off the sides.

It is of especial advantage if the operating elements and the display field of the MPeg player are arranged on a long side, so that the operating and display elements are able to be placed in a clear manner, with plenty of space between them, which is important when driving an automobile.

In order to be able to load a music selection from a PC into the memory of the MPeg player, the latter is especially furnished with an USB interface, preferably with a USB plug that is fastened directly to the housing of the MPeg player. Consequently, there is no need to carry along additional cable. A protective cover gives protection to the USB plug, and it is flipped over at the plug when the MPeg player is going to be carried along.

The MPeg player is able to have particularly small measurements if the operating elements as well as the display field of the MPeg player are arranged on an elongated side, and there are electrical contacts on at least one end face, one earphone socket in particular, and one current supply socket being situated on one end face, and one USB plug being situated on an opposite end face. Elongated plug pins may thereby reach into the elongated region, whereby a flat and narrow housing is able to be implemented that has the shape of a parallelepiped. A protective cap for the USB plug may close on the housing in an attractively styled manner.

### BRIEF DESCRIPTION OF THE DRAWINGS

FIG. 1 shows a schematic representation of an automobile radio according to the present invention having an integrated MP3 player.

FIG. 2 shows a schematic representation of the MP3 player, having parts exploded.

FIG. 3 shows a schematic representation of the MP3 player, having parts assembled.

FIG. 4 shows a schematic representation of the MP3 player in use as a mobile unit.

### DETAILED DESCRIPTION

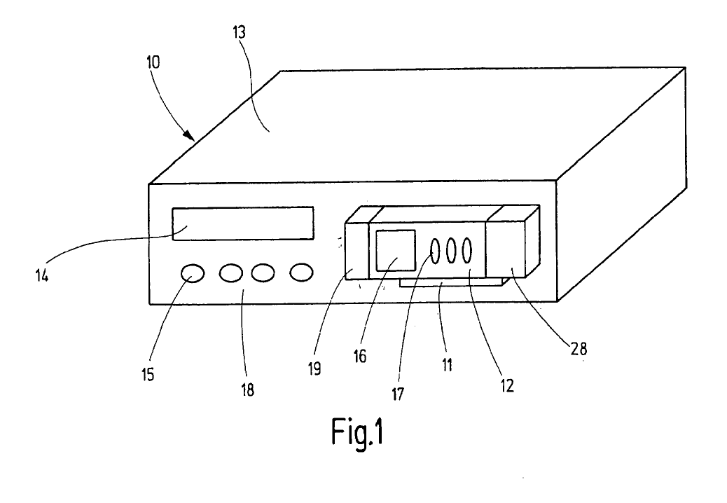

FIG. 1 illustrates an automobile radio 10 having an integratable MP3 player 12. The automobile radio that includes the radio part and that can be built into a console, is made up of a base part 13 as well as the removable MP3 player. MP3 player 12 is developed, so to speak, as an installation module. In an inserted state, this forms a unit together with base part 13. Both the base part and the MP3 player have display and operating elements 14 to 17.

When the MP3 player is removed from base part 13, it can be used as a portable unit, as usual while running or on a bus, so that the user can hear digitized music that was stored before in the MP3 player. The MP3 player is relatively small, since only a digital memory is present, and no drives or data carriers such as CD drives or CD's or cassettes having an appropriate drive are needed. The memory, for instance, has a storage capacity of (at least) 256 Mbytes, and may be developed in an integrated fashion or as a card, such as an SD card.

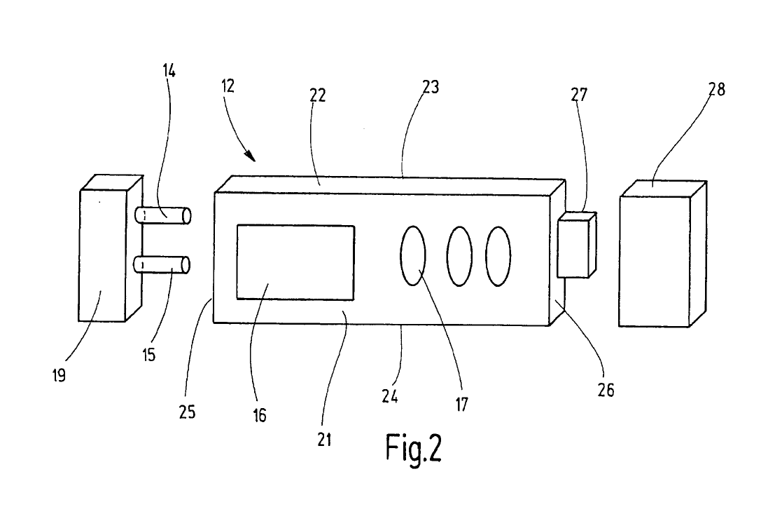

Base part 13 and the MP3 player are provided with appropriate electrical contacts which produce a transmission connection in the assembled state, the contacts of base part 13 being shown in FIG. 2, and the contacts of the MP3 player are not visible. The transmission connection is particularly provided only for audio signals and voltage supply signals, and not for other signals, such as control signals for the operation of the MP3 player.

Base part 13 has a freely accessible front 18, which can be comfortably accessed in the inserted state by a traveling person.

According to the present invention, operating elements 17 and display field 16 of MP3 player 12 are situated on front face 18, in the inserted state, so that they are able to be operated. They may run, for instance, in the plane of front face 18, for example, when the MP3 player is situated in a push-in compartment, they may be positioned slightly recessed in base part 13, in practice behind the front face plane, or, as shown, forward of front face 18 and/or even slantwise, or rather, not parallel to the front face plane. MP3 player 12 may rest upon front face 12, as shown, so that display field 16 and operating elements 17 are situated offset by approximately the thickness of MP3 player 12 to display and operating elements 14, 15 of base part 13.

Operating elements 17 are situated in such a way, according to the present invention, that they are also able to be operated in the linked-up state. The corresponding applies to display field 16.

MP3 player 12 of this preferred design approach is equipped with a jack connector socket (not shown), for instance, a normalized 2.5 mm or 3.5 mm socket, for an earphone or a pair of earphones. Base part 13 has a fitting plug 14 that is shown in FIG. 2. Plug 14 is used for the transmission of analog audio signals of MP3 player 12, which is amplified by an audio amplifier in base part 13, so that reproduction of music is able to take place via the loudspeakers installed in the vehicle.

Parallel to plug 14, an additional plug 15 is present at base part 13, MP3 player 12 being equipped with a voltage supply jack connector socket, that is also not shown, for instance, also a normalized 2.5 mm or a 3.5 mm socket. using this, base part 13 supplies MP3 player 12 with electrical energy, so that the accumulators of MP3 player 12 are conserved. In particular, a charging function for the accumulators of MP3 player 12 is also implemented via this plug 15.

Both plugs 14 and 15 that are situated, for example, one over the other, are fastened on a plug piece 19, which is preferably connected firmly to base part 13, and, for example, lies on front face 18 of base part 13. Basically, plug part 19 may also be removable and thus also freely movable, for instance, via a cable connection and a snap-in connection to base part 13. Such a design approach may be expedient if MP3 player 12 is to rest in a compartment. A swivel design approach is also conceivable.

With the aid of plug part 19 and its connecting plugs, a docking station to the radio/amplifier unit is implemented.

Furthermore, besides a mechanical fastening function of plugs 14 and 15, at least one retaining element 11 may be present on base part 13.

The MP3 player is preferably designed as a stick. This stick shape, which reminds one of the shape and size of a usual text marker, benefits from great acceptance.

In principle, MP3 player 12 has an elongated, slightly parallelepiped-shaped construction, four elongated sides 21 to 24 being able to be assigned. Bigger sides 21 and 23 and narrower sides 22 and 24 are respectively approximately parallel. These sides 21 to 24 may also be slightly arched, for design reasons. Furthermore there are two relatively small sides as end faces 25, 26, these being also slightly rounded off.

Longitudinal side 21 that lies out in front is narrower than front face 18 of base part 13, preferably only approximately 30% to 70% narrower and also shorter, preferably 30% to 70% shorter.

Operating elements 17 as well as display field 16 of MP3 player 12 are situated on longitudinal side 21, while the sockets for plugs 14, 15 are on narrow side 25.

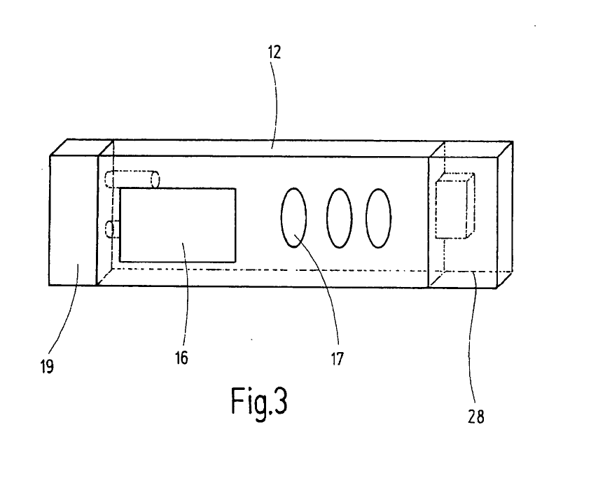

MP3 player 12 has on its end face 26, lying opposite to side 25, a USB interface for storing digitized musical pieces by a PC or a USB port that is implemented by a USB plug 27 shown in FIGS. 2 and 3. A protective cover 28 or a protective cap for USB plug 27 protects it during use of MP3 player 12 as a portable unit, but also when it is used in the automobile radio. MP3 player 12 is thus able to be plugged directly into a PC port. A PC connecting cable may just as well be used.

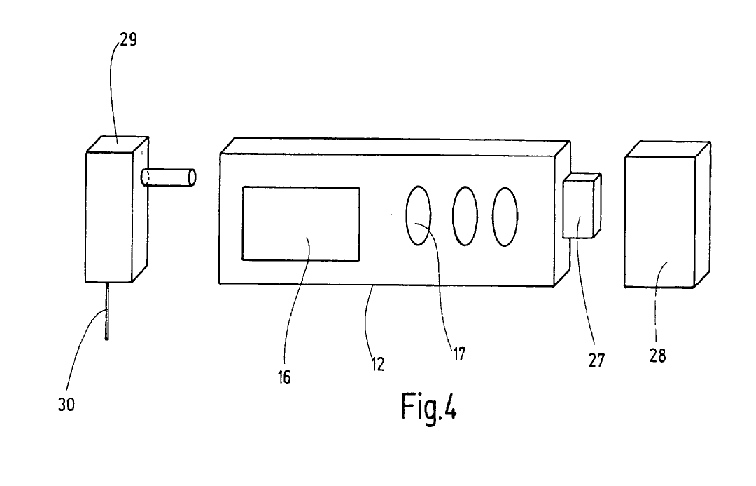

FIG. 4 illustrates that an earphone pair may be plugged in using an earphone plug 29 having an earphone cable 30.

It should be mentioned here that each individual feature described is able to be combined with every other described feature.

Every unit having a digital music reproduction memory is designated as an MPeg player within the meaning of this specification.

1-12. (canceled)

13. An automobile radio into which an MPeg player developed as an insertion module is able to be inserted in such a way that operating elements and a display field of the Mpeg player are situated on a front face in an inserted state, so that they are able to be operated, and the Mpeg player being able to be removed again from the automobile radio, the automobile radio comprising:
a base part including at least one radio part, the base part forming one unit with the inserted MPeg player, the base part having a freely accessible front face, the base part having electrical contacts corresponding to the MPeg player, which produce a transmission connection in the inserted state, the base part having display elements and operating elements.

14. The automobile radio according to claim 13,
wherein the Mpeg player is equipped with an earphone socket, including a jack connector socket, and the base part has a fitting plug for a transmission of analog audio signals of the MPeg player.

15. The automobile radio according to claim 13,
wherein the base part has a plug for a voltage supply of the MPeg player.

16. The automobile radio according to claim 13,
wherein the base part includes a charging function for accumulators of the MPeg player.

17. The automobile radio according to claim 16,
wherein a charging process of the accumulators is implemented via a current supply socket of the MPeg player.

18. The automobile radio according to claim 13,
wherein the MPeg player has an elongated, substantially parallelepiped-shaped construction, including four elongated sides being present and two small sides being present as end faces, including at least one of rounded-off and arched sides.

19. The automobile radio according to claim 18,
wherein the operating elements and the display field of the MPeg player are situated on one longitudinal side.

20. The automobile radio according to claim 13,
wherein the base part is equipped with a USB interface.

21. The automobile radio according to claim 13,
wherein the base part is equipped with a USB plug.

22. The automobile radio according to claim 13,
wherein the MPeg player is equipped with a USB plug, and has a protective cover for the USB plug, for use as a portable unit.

23. The automobile radio according to claim 13,
wherein the operating elements and the display field of the MPeg player are situated on an elongated side, and electrical contacts are situated on at least one end face, including one earphone socket and one current supply socket being situated on one end face and a USB plug being situated on an end face lying opposite to it.

24. The automobile radio according to claim 13,
wherein the base part is built into a console.
